(19) United States
(12) Patent Application Publication
(10) Pub. No.: US 2007/0002375 A1
(43) Pub. Date: Jan. 4, 2007

(54) Segmenting and aligning a plurality of cards in a multi-card image

(75) Inventor: Du-Yong Ng, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/170,949

(22) Filed: Jun. 30, 2005

(51) Int. Cl. G06K 15/00

(52) U.S. Cl. 358/1.18; 358/1.12

(57) ABSTRACT

A method of segmenting and aligning a plurality of cards in a multi-card image, each card of the plurality of cards having at least one object, the multi-card image having a plurality of the objects, includes determining which pixels of the multi-card image are content pixels; grouping together a plurality of the content pixels corresponding to each object of the plurality of the objects to form a cluster corresponding to the each object, the grouping performed for the plurality of the objects to create a plurality of clusters corresponding to the plurality of the objects; determining which clusters of the plurality of clusters should be joined together to form a plurality of superclusters; and forming the plurality of superclusters, each supercluster of the plurality of superclusters corresponding to one card of the plurality of cards.

### BACKGROUND OF THE INVENTION

1. Field of the Invention

The present invention relates to image processing, and, more particularly, to segmenting and aligning a plurality of cards in a multi-card image.

2. Description of the Related Art

Among images sought to be reproduced by users of imaging systems are multi-card images generated by the user placing several cards, photographs, etc., on a scanner bed of an imaging apparatus and scanning or copying the multi-card image. Typically, the cards are not placed on the scanner bed in an orderly fashion, as doing so requires extra effort on the part of the user. Nonetheless, it is desirable that the reproduced multi-card image appear orderly.

Segmentation is an essential part of image processing, and constitutes the first path of the process of an imaging system perceiving a multi-card image. Before the content of an image can be deciphered or recognized, it needs to be separated from the background. If this process is not performed correctly, the extracted content can be distorted and misinterpreted. The accuracy of content segmentation is important in applications that apply optical character recognition (OCR) to the content. Since OCR is also sensitive to the skew of content, e.g., text, it is desirable to correct for the skew of the content during the segmentation. An example of this class of applications is detecting texts and extracting useful information of individual cards (such as business cards) from a multi-card scanned image.

Prior art methods to segment and align cards are typically based on an algorithm that detects the edges of the scanned cards or photographs in order to determine the position and/or skew angle of each card. However, the edges of cards are often not visible or otherwise detectable in the scanned image, and accordingly, segmentation and alignment may not be performed accurately.

What is needed in the art is a method of segmenting and aligning a plurality of cards in a multi-card image without relying on or employing edge detection.

### SUMMARY OF THE INVENTION

The present invention provides an apparatus and method for segmenting and aligning a plurality of cards in a multi-card image without relying on or employing edge detection.

The invention, in one exemplary embodiment, relates to a method of segmenting and aligning a plurality of cards in a multi-card image, each card of the plurality of cards having at least one object, the multi-card image having a plurality of the objects. The method includes determining which pixels of the multi-card image are content pixels; grouping together a plurality of the content pixels corresponding to each object of the plurality of the objects to form a cluster corresponding to each object, the grouping performed for the plurality of the objects to create a plurality of clusters corresponding to the plurality of the objects; determining which clusters of the plurality of clusters should be joined together to form a plurality of superclusters; and forming the plurality of superclusters, each supercluster of the plurality of superclusters corresponding to one card of the plurality of cards.

The invention, in another exemplary embodiment, relates to an imaging apparatus communicatively coupled to an input source and configured to receive a multi-card image. The imaging apparatus includes a print engine and a controller communicatively coupled to the print engine. The controller is configured to execute instructions for segmenting and aligning a plurality of cards in a multi-card image, each card of the plurality of cards having at least one object, the multi-card image having a plurality of the objects. The instructions include determining which pixels of the multi-card image are the content pixels; grouping together a plurality of the content pixels corresponding to each object of the plurality of the objects to form a cluster corresponding to each object, the grouping performed for the plurality of the objects to create a plurality of clusters corresponding to the plurality of the objects; determining which clusters of the plurality of clusters should be joined together to form a plurality of superclusters; and forming the plurality of superclusters, each supercluster of the plurality of superclusters corresponding to one card of the plurality of cards.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system in accordance with an embodiment of the present invention.

FIG. 2 depicts a plurality of cards in a multi-card image as might be segmented and aligned in accordance with an embodiment of the present invention.

FIG. 3 is a flowchart depicting a method of segmenting and aligning a plurality of cards in a multi-card image in accordance with an embodiment of the present invention.

FIGS. 4A-4G are a flowchart that depicts a method of segmenting and aligning a plurality of cards in a multi-card image in accordance with an embodiment of the present invention.

FIG. 5 depicts bounding boxes for, and vertices of, each cluster, as determined in accordance with the embodiment of FIGS. 4A-4G.

FIG. 6 depicts a multi-card image that was segmented and aligned in accordance with the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

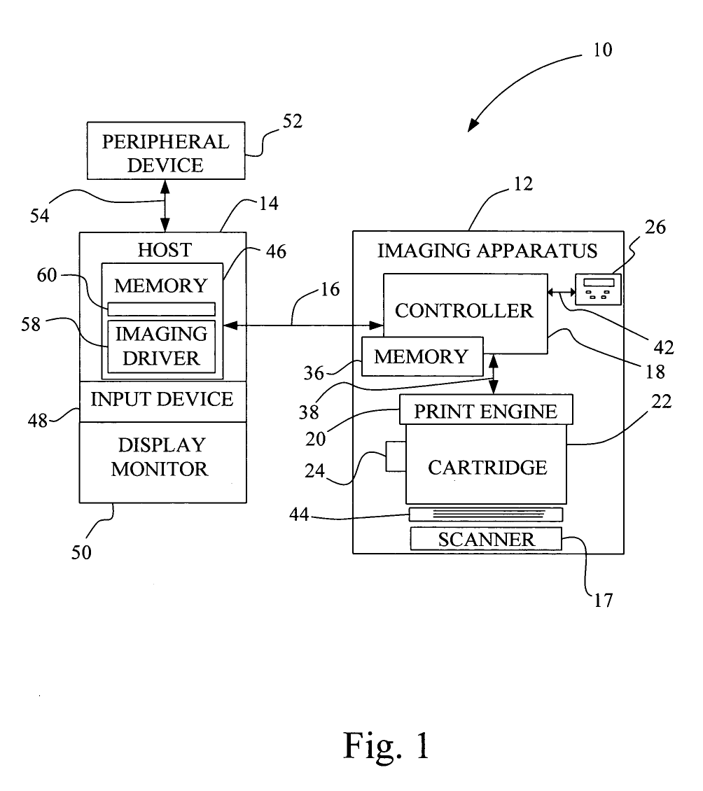

Referring now to the drawings, and particularly to FIG. 1, there is shown a diagrammatic depiction of an imaging system 10 in accordance with an embodiment of the present invention. Imaging system 10 includes an imaging apparatus 12 and a host 14. Imaging apparatus 12 communicates with host 14 via a communications link 16.

Imaging apparatus 12 can be, for example, an ink jet printer and/or copier, an electrophotographic (EP) printer and/or copier, or an all-in-one (AIO) unit that includes a printer, a scanner 17, and possibly a fax unit. Imaging apparatus 12 includes a controller 18, a print engine 20, a replaceable cartridge 22 having cartridge memory 24, and a user interface 26.

Controller 18 is communicatively coupled to print engine 20, and print engine 20 is configured to mount cartridge 22. Controller 18 includes a processor unit and associated memory 36, and may be formed as one or more Application Specific Integrated Circuits (ASIC). Controller 18 may be a printer controller, a scanner controller, or may be a combined printer and scanner controller, for example, such as for use in a copier. Although controller 18 is depicted as residing in imaging apparatus 12, alternatively, it is contemplated that all or a portion of controller 18 may reside in host 14. Nonetheless, as used herein, controller 18 is considered to be a part of imaging apparatus 12. Controller 18 communicates with print engine 20 and cartridge 22 via a communications link 38, and with user interface 26 via a communications link 42. Controller 18 serves to process print data and to operate print engine 20 during printing.

In the context of the examples for imaging apparatus 12 given above, print engine 20 can be, for example, an ink jet print engine or an electrophotographic print engine, configured for forming an image on a substrate 44, which may be one of many types of print media, such as a sheet of plain paper, fabric, photo paper, coated ink jet paper, greeting card stock, transparency stock for use with overhead projectors, iron-on transfer material for use in transferring an image to an article of clothing, and back-lit film for use in creating advertisement displays and the like. As an ink jet print engine, print engine 20 operates cartridge 22 to eject ink droplets onto substrate 44 in order to reproduce text or images, etc. As an electrophotographic print engine, print engine 20 causes cartridge 22 to deposit toner onto substrate 44, which is then fused to substrate 44 by a fuser (not shown). In the embodiment depicted, imaging apparatus 12 is an ink jet unit.

Host 14 may be, for example, a personal computer, including memory 46, an input device 48, such as a keyboard, and a display monitor 50. One or more of a peripheral device 52, such as a digital camera, may be coupled to host 14 via communication links, such as communication link 54. Host 14 further includes a processor, and input/output (I/O) interfaces. Memory 46 can be any or all of RAM, ROM, NVRAM, or any available type of computer memory, and may include one or more of a mass data storage device, such as a floppy drive, a hard drive, a CD drive and/or a DVD drive. As set forth above, memory 36 of imaging apparatus 12 stores data pertaining to each particular cartridge 22 that has been installed in imaging apparatus 12. However, it is alternatively contemplated that memory 46 of host 14 may store such data.

During operation, host 14 includes in its memory 46 program instructions that function as an imaging driver 58, e.g., printer/scanner driver software, for imaging apparatus 12. Imaging driver 58 is in communication with controller 18 of imaging apparatus 12 via communications link 16. Imaging driver 58 facilitates communication between imaging apparatus 12 and host 14, and provides formatted print data to imaging apparatus 12, and more particularly, to print engine 20. Although imaging driver 58 is disclosed as residing in memory 46 of host 14, it is contemplated that, alternatively, all or a portion of imaging driver 58 may be located in controller 18 of imaging apparatus 12.

During operation, host 14 also includes in its memory 46 a software program 60 including program instructions for segmenting and aligning a plurality of cards in a multi-card image. Although depicted as residing in memory 46 along with imaging driver 58, it is contemplated that, alternatively, all or a portion of software program 60 may be formed as part of imaging driver 58. As another alternative, it is contemplated that all or a portion of software program 60 may reside or operate in controller 18.

The present description of embodiments of the present invention applies equally to operations of software program 60 executing in controller 18 or as part of imaging driver 58, and any reference herein to instructions being executed by controller 18 is intended as an expedient in describing the present invention, and applies equally to instructions being executed by controller 18 and/or instructions executed as part of imaging driver 58 and/or instructions executed as part of a separate software program 60 for performing segmentation and alignment of a plurality of cards in accordance with the present invention. As used herein, imaging driver 58 and software program 60 may be considered to be a part of imaging apparatus 12.

In accordance with the present invention, a plurality of cards, for example, business cards, photos, greeting cards, etc., may be placed on scanner 17, e.g., on a scanner bed or platen, by a user, and are segmented and aligned using software program 60. For example, users typically do not place such cards on the scanner bed in an orderly fashion, as doing so requires extra time and effort to align the cards appropriately.

Thus, the placed cards are typically skewed and not in an orderly arrangement, and when printed, yields an image having a disorderly appearance. Software program 60 electronically segments and aligns the cards to provide an image having an orderly appearance, which may be printed and conveniently employed by the user. Segmentation and alignment refer herein to electronically segmenting content pixels from background pixels and separating each card from a multi-card image obtained by scanning or copying a plurality of cards, and aligning the cards to form a multi-card image, for example, having an orderly appearance.

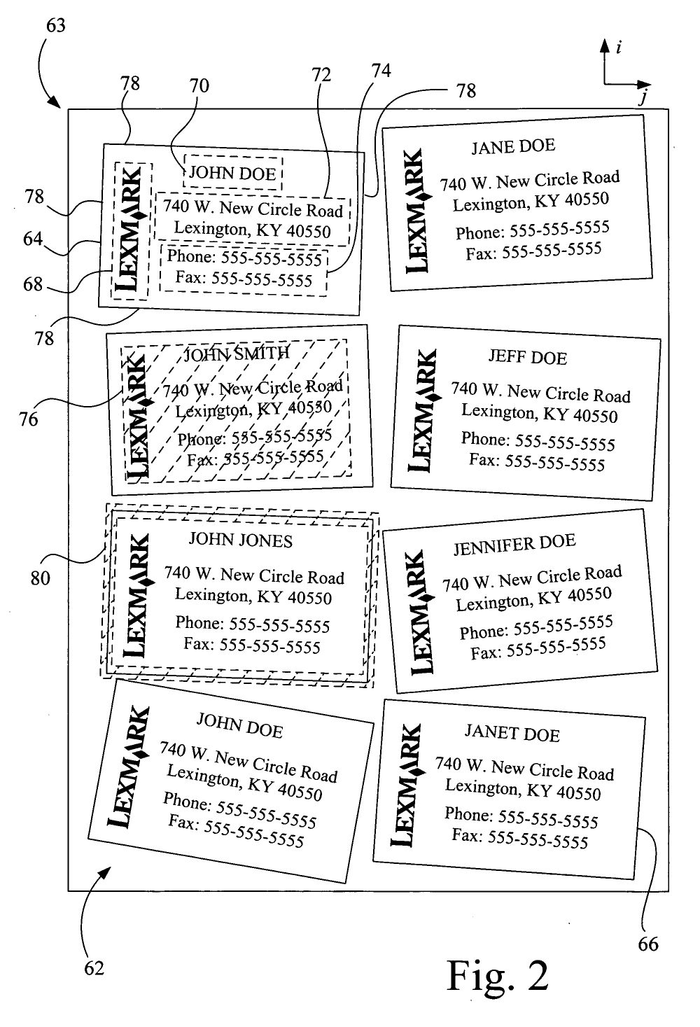

Referring now to FIG. 2, a plurality of cards 62 as placed on scanner 17 by a user is depicted. When scanned by scanner 17, plurality of cards 62 yields a multi-card image 63 in the form of pixels generated by scanner 17, controller 18, and imaging driver 58. The pixels that form multi-card image 63 include background pixels and content pixels. As the name implies, the background pixels are those image pixels that represent the background of multi-card image 63, whereas content pixels are those pixels that represent the content of the plurality of cards 62, e.g., the logos, names, and addresses, etc. In other words, the content pixels are those pixels that pertain to the image contents of the card that is sought to be reproduced. For cards in the form of greeting cards or photos, etc., the content pixels would represent, for example, the scenery, people, structures, and other features that are the objects of the photograph or greeting card.

In the context of the present description of an embodiment of the present invention, the term, “card,” pertains to a business card, a photograph, a greeting card, or other similar such bearer of content as might be placed severally on the bed of a scanner, copier, etc., and scanned or copied as a group. It will be understood that the term, “card,” shall not be limited to business cards, photographs, or greeting cards, but rather, that such cards are merely exemplifications used for convenience in describing the present invention.

Each scanned card, for example, card 64 and card 66, includes at least one object, for example, object 68, object 70, object 72, and object 74 of card-64, that are located in an interior region 76 of each card. Interior region 76 is that portion of each card that contains content, e.g., content pixels that form the objects, e.g., objects 68, 70, 72, and 74. The term, object, as used herein, pertains to, for example, the logos, names and addresses, etc., of business cards, as well as the features of, for example, photographs and greeting cards, e.g., scenery and other objects of photographs and greeting cards, etc., that are formed of content pixels. As illustrated in FIG. 2, each card of plurality of cards 62 has edges 78 that are within a boundary region 80. Boundary region 80 is the area each card that includes edges 78, but does not include interior region 76, i.e., does not include any of the content pixels that form the objects, e.g., objects 68, 70, 72, and 74, which are located only in interior region 76.

The edges 78 of the cards may not always be visible in multi-card image 63, and thus, edges 78 may be unreliable indicators of the position and alignment of the cards in multi-card image 63. Accordingly, the present invention performs image segmentation and alignment without detecting edges 78 as being edges of the cards. Although edge pixels may be grouped as part of an image pertaining to a card, the edge pixels are not used to determine the location or skew angles of the cards. That is, the present invention does not detect the edges in boundary region 80 in order to perform segmentation and alignment, but rather, operates by finding the objects of each card, which are then used to determine the location and skew of each card. Thus, the present invention segmentation and alignment is performed based on using pixels only in the interior region of each card. By not relying on edge detection in order to segment and align the cards, the present invention has an advantage over prior art methods, since the edges of the cards may not be present in the scanned multi-card image. Thus, the present invention is able to segment and align cards in a multi-card image where the edges are not detectable, whereas prior art methods that rely on edge detection may not be able to do so.

The present invention segmentation and alignment algorithm is an adaptive algorithm that detects and separates individual cards in a multi-card image, and positions the cards to any desired orientation, regardless of the original skew angle of each card on the image. The present embodiment analyzes the local content and identifies the direction in which the local content should be grouped using the size of the card as the termination criterion for the grouping. The size of the cards can be varied for different applications. When a card is identified, the skew angle of the content is determined and corrected automatically so that the card can be re-positioned accordingly to the desired orientation. The present invention works for images with any background color and content (not only texts), and it works effectively in the absence of edges, unlike prior art algorithms. The present invention is also efficient in that it segments cards in a high-resolution image almost as quickly as a low-resolution counterpart. In addition, the present invention is an ideal tool to segment and de-skew multi-photograph scanned images.

It is seen in FIG. 2 that the cards are not arranged in an orderly fashion, e.g., the cards are not aligned with one another in an aesthetically pleasing fashion.

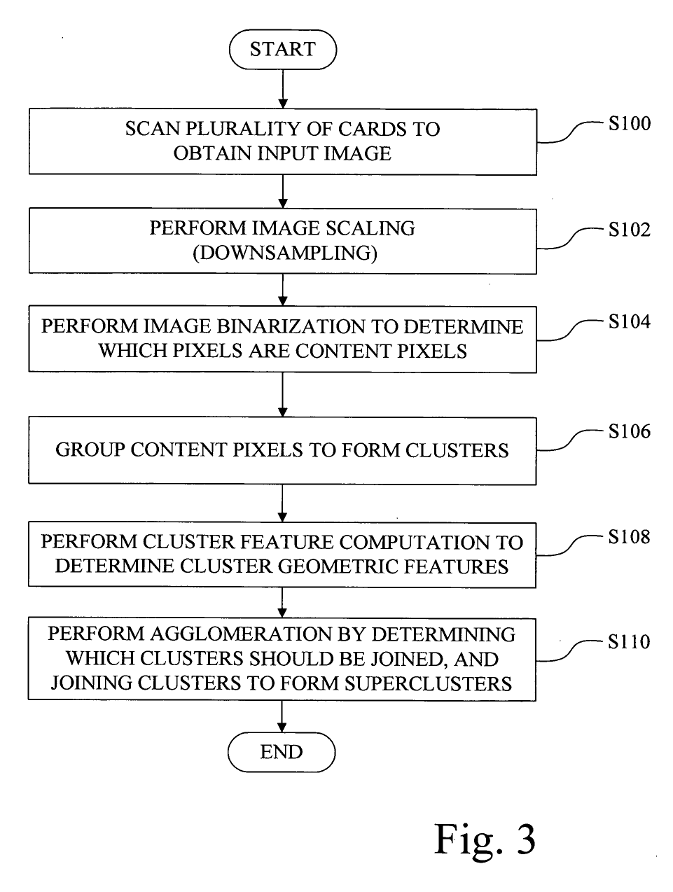

Referring now to FIG. 3, a method of segmenting and aligning a plurality of cards in a multi-card image, each card of the plurality of cards having at least one object, the multi-card image having a plurality of the objects, in accordance with an embodiment of the present invention is depicted in the form of a flowchart, with respect to steps S100-S110. Following a description of the present embodiment algorithm is a list of variables employed in the algorithm.

At step S100, multi-card image 63 is placed on scanner 17 by a user, and is scanned to obtain an input image, imgln.

At step S102, downsampling of the input image is performed to scale the image.

The input image imgln is downsampled to an appropriate size to speed up the segmentation process. The downsampling algorithm could be any resampling algorithm such as nearest neighbor, bilinear or bicubic-spline interpolation. The downsampling/image scaling process can be skipped without affecting the effectiveness of the present invention. In the present embodiment, imgIn is assumed to be downsampled using bilinear interpolation to imgInD of resolution R dpi by s times, where s is a positive real number. Thus, R is the resolution of the downsampled input image imgInD, whereas s is the downsampling factor.

At step S104, image binarization is performed to determine which pixels of multi-card image 63 are content pixels.

The binarization process segregates the background pixels from those of the content. Let imgInD(k,i,j) denote the pixel value of the k^{th} channel of the downsampled input image imgInD at spatial location (i, j). The color of the background colorBG is first determined. This color can be defined as the color of the majority pixels of the image or set to any desired color. A binary 2D map bInMap may be generated for imgInD as follows.

$$bInMap ( i , j ) = {\prod }_{k = 0}^{N} g ( {α}_{k} , imgInD ( k , i , j ) , {color}_{BG} ( k ) ) \\ where \\ g ( α , β , γ ) = \{ \begin{matrix}1 , & ‖ β - γ ‖ \leq α \\ 0 , & otherwise\end{matrix} \qquad ( 1 )$$

Π(·) denotes multipication operation;

αₖ denotes the bound within which imgInD(k, i, j) is classified as background pixel for channel k, and kε{1,2, . . . , N}.

For a 24-bit color image with white background, the binary map may be calculated with the following parameters:

a) N=3,

b) color_{BG}(k)={255: kε{1,2,3}} and

c) αₖ={noise variance of channel k:k ε{1,2,3}}

The parameter α can be set to any desired value and it can also be uniform across channels if necessary. The pixels in bInMap corresponding to 0 and 1 are those of the background and content respectively. In the present example, the background pixels are white and content pixels are black.

At step S106, a plurality of content pixels corresponding to each object of the plurality of objects are grouped to form “superpixels,” or clusters, wherein a cluster corresponds to each object, e.g., objects 68, 70, 72, and 74. The grouping is performed for the plurality of objects of multi-card image 63 to create a plurality of clusters corresponding to the plurality of objects, e.g., so that there is a cluster of pixels associated with each object. Each cluster is numbered for future reference by the present invention algorithm.

The grouping together of the plurality of content pixels includes searching the multi-card image in raster order until a first content pixel is located, grouping with the first pixel the neighboring content pixels that are within a predetermined spatial proximity of the first content pixel to form an initial cluster, determining which content pixels of the initial cluster are boundary pixels, and grouping with the initial cluster the neighboring content pixels that are within the predetermined spatial proximity of each boundary pixel of the boundary pixels to form the cluster. The process is repeated to determine each cluster.

In the present embodiment, window-based pixel clustering is employed. Content pixels in close spatial proximity are bound together to form the clusters. This step reduces computation for grouping to form objects or cards in step S110, and is performed in raster order, e.g., along each raster line sequentially. The clustering algorithm operates on bInMap.

The clustering is performed as follows:

a) Assign a cluster label to the first content pixel encountered in raster order.

b) Center a d×d square window at the content pixel and search for boundaries within which content pixels are found in this window. Although the present embodiment employs a square window, it will be recognized that any window shape may be employed without departing from the scope of the present invention, for example, a rectangular window.

c) Assign the same cluster label to the content pixels within the boundaries.

d) Repeat the above steps (a) to (c) for all the boundary pixels and content pixels within the window centered at the boundary pixels that have not been searched and labeled.

e) Increment the cluster label when all the boundary pixels have been searched.

f) Repeat the above steps (a)-(e) for all the content pixels that have not been searched and labeled.

At step S108, geometric features are determined for each cluster of the plurality of clusters in preparation for determining which clusters should be joined together.

Each of the clusters has properties, e.g., as set forth below, that are employed in forming superclusters in step S110. For example, suppose that M clusters are found. Let Pₘ be the set of points, p's (where p=(i,j)), corresponding to the content pixels of the m^{th} cluster, e.g., cluster m. In the present embodiment, the properties of the m^{th} cluster are calculated based on the following:

a) Total number of content pixels:

$${totNumPix}_{m} = {\sum }_{p ∈ {P}_{m}} ( 1 - bInMap ( p ) ) \qquad ( 2 )$$

b) Mean of the spatial location of all the pixels in the cluster:

$${i\_mean}_{m} = ( {\sum }_{p ∈ {P}_{m}} i ) / {totNumPix}_{m} \\ {j\_mean}_{m} = ( {\sum }_{p ∈ {P}_{m}} j ) / {totNumPix}_{m} \qquad ( 3 )$$

c) Bounds of the cluster:
i_minₘ=min(i: pεPₘ)
i_maxₘ=max(i: pεPₘ)
j_minₘ=min(j: pεPₘ)
j_maxₘ=max(j: pεPₘ) (4)
A bounding box for the cluster is determined from these parameters.

d) Initialize the cluster dimension:
clusterHeightₘ=i_maxₘ−i_minₘ
clusterWidthₘ=j_maxₘ−j_minₘ (5)

These parameters will be replaced with the actual cluster dimension after the skew angle adjustment of step S110.

e) Sample spatial covariance matrix:

$${C}_{m} = \frac{1}{{totNumPix}_{m} - 1} multiplied by \text{:} [ \begin{matrix}{\sum }_{p ∈ {P}_{m}} {( i - {i\_mean}_{m} )}^{2} & {\sum }_{p ∈ {P}_{m}} ( i - {I\_mean}_{m} ) \cdot ( j - {j\_mean}_{m} ) \\ {\sum }_{p ∈ {P}_{m}} ( i - {i\_mean}_{m} ) \cdot ( j - {j\_mean}_{m} ) & {\sum }_{p ∈ {P}_{m}} {( j - {j\_mean}_{m} )}^{2}\end{matrix} ] \qquad ( 6 )$$

f) Four vertices, one along each side of the bounding box of the clusters:
p_{—}v1ₘ=(i_minₘ,j),(i,j)εPₘ
p_{—}v2ₘ=(i_maxₘ,j),(i,j)εPₘ
p_{—}v3ₘ=(i,j_minₘ),(i,j)εPₘ
p_{—}v4ₘ=(i,j_maxₘ),(i,j)εPₘ (7)

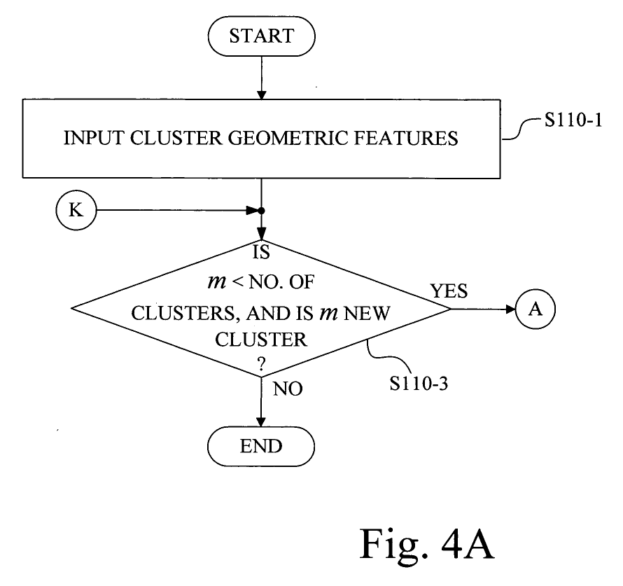

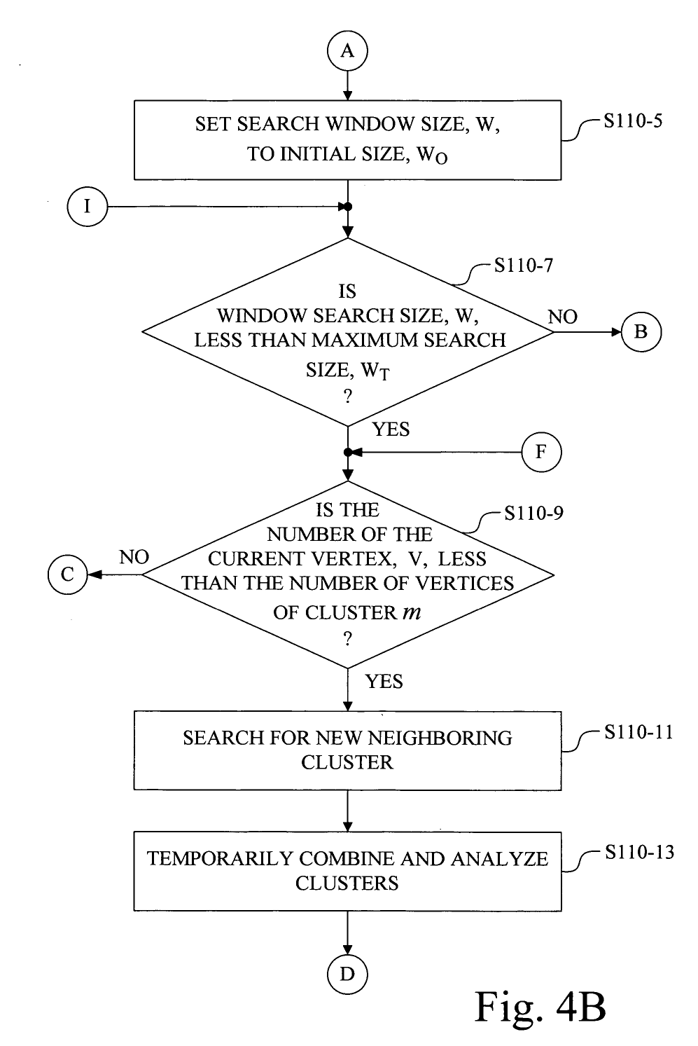

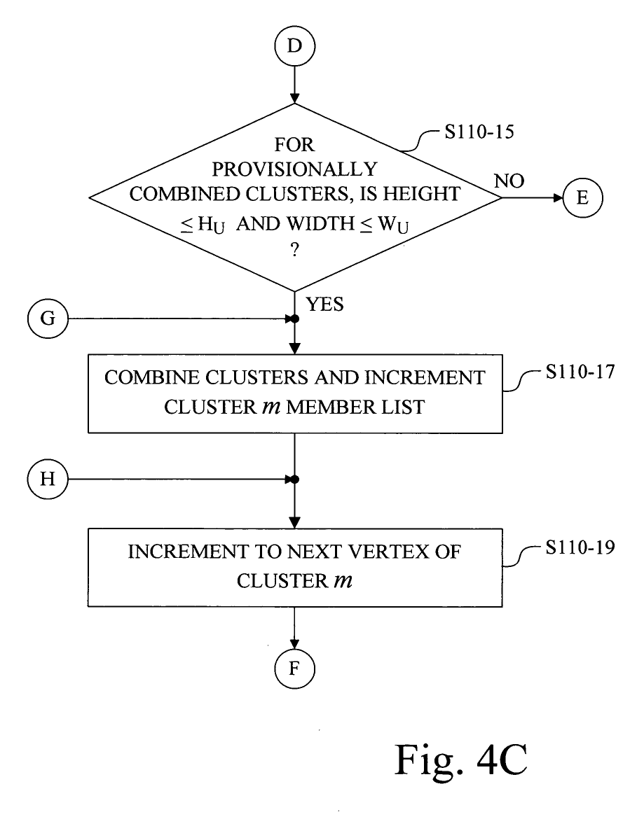

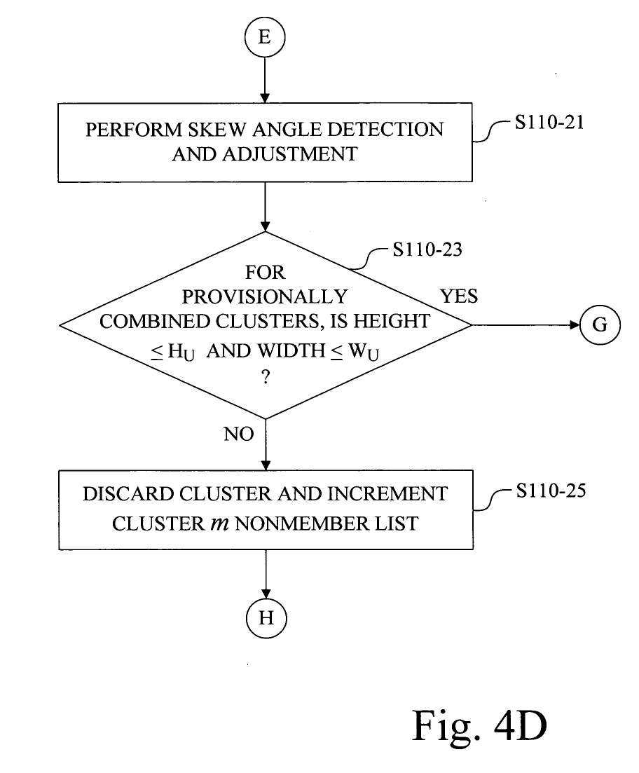

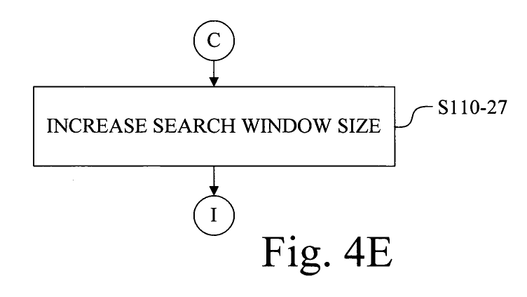

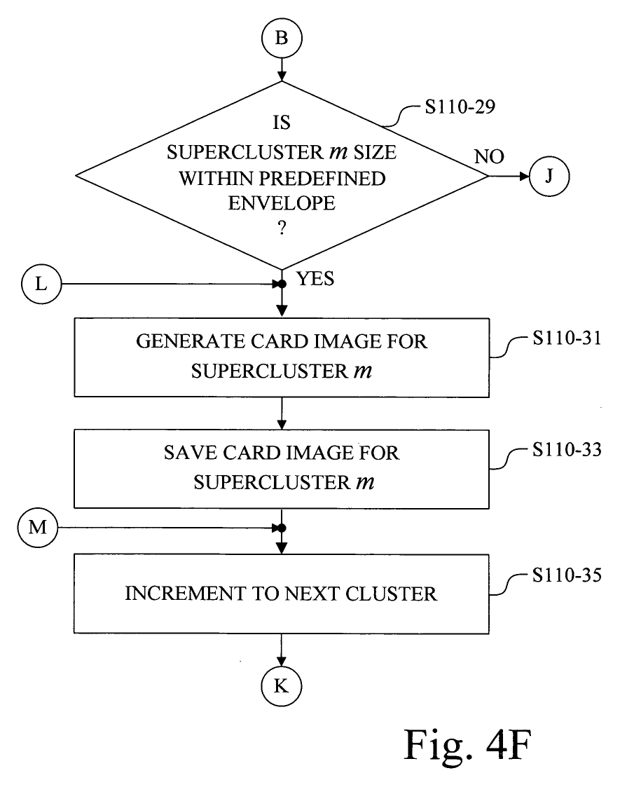

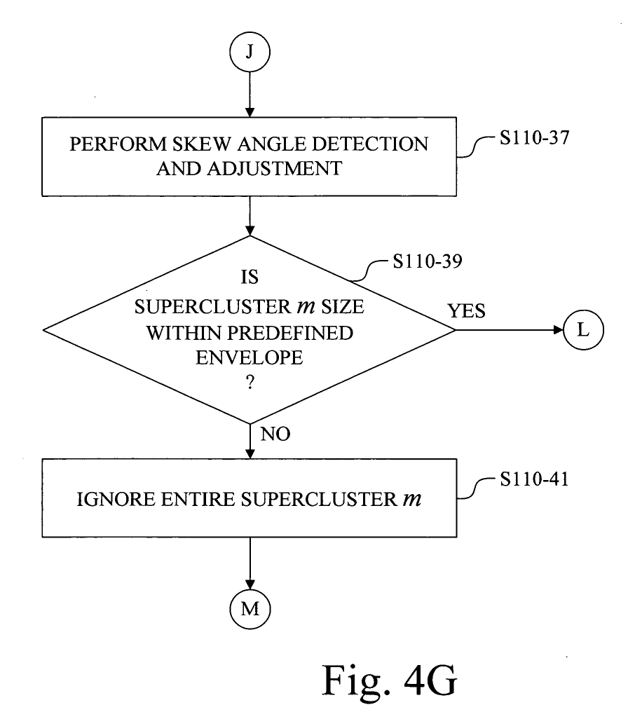

At step S110, agglomeration is performed by determining which clusters of the plurality of clusters should be joined together, e.g., grouped, to form a plurality of superclusters, and by forming the plurality of superclusters. Each supercluster of the plurality of superclusters corresponds to one card of the plurality of cards, i.e., upon completion of step S110, each final supercluster pertains to a card in multi-card image 63. The agglomeration includes determining a spatial relationship between each card of plurality of cards 62, and aligning plurality of cards 62. Step S110 is explained in greater detail below with respect to FIGS. 4A-4G and steps S110-1 to S110-41.

Referring now to FIG. 4A, at step S110-1, the cluster geometric features determined in step S108 provided as inputs to the agglomeration algorithm of S110, and variables used in the algorithm are initialized.
Member list, MLₘ={m}
Non-member list, NMLₘ{ }
IgnoreClusterFlagₘ=FALSE
ImageGeneratedFlagₘ=FALSE
HasBeenSearchedₘ=FALSE (8)

The member list is a list of clusters are to be joined together, i.e., agglomerated, with a given cluster, e.g., designated cluster m in step S110, and is used to keep track of those clusters that have been joined together with the particular designated cluster. Cluster m is that cluster for which the present embodiment algorithm is searching for other clusters to group therewith to form a supercluster, which is a group of clusters. The variable m is incremented until all clusters have been searched. Upon completion of step S110 (S110-1-S110-41), all the clusters that have been agglomerated become superclusters representative of individual cards of plurality of cards 62 that are segmented in accordance with the present invention. The use of the member list avoids redundant searching for clusters to join with designated cluster m. For example, by checking the member list, the algorithm can avoid rechecking clusters that have already been tested for agglomeration.

The non-member list keeps track of clusters that have been looked at for joining with the designated cluster or have been provisionally joined with the designated cluster, but have been determined not appropriate to group with the designated cluster, e.g., in the case where the provisionally grouped clusters do not fit within a predefined envelope. The use of the member list also avoids redundant searching for clusters to join with designated cluster m, e.g., in a similar manner as does the member list.

The IgnoreClusterFlag is a flag that when set for a cluster indicates for the algorithm to ignore clusters that are smaller than a predefined value as most likely corresponding to noise pixels in the original image.

The ImageGeneratedFlag is a flag that when set indicates that a final supercluster has been agglomerated for a card, and that an image for the supercluster has been generated.

HasBeenSearched parameter pertains to a flag that indicates that the designated cluster m has been searched for combining other clusters with.

Each of the aforementioned flags help speed up the present invention algorithm by eliminating unnecessary searching activities.

If small clusters can be ignored to speed up the grouping process, then, set IgnoreClusterFlagₘ=TRUE if the totNumPixₘ, e.g., the total number of pixels in multi-card image, is less than a threshold. The ignored clusters will not be considered for the grouping process of step S110.

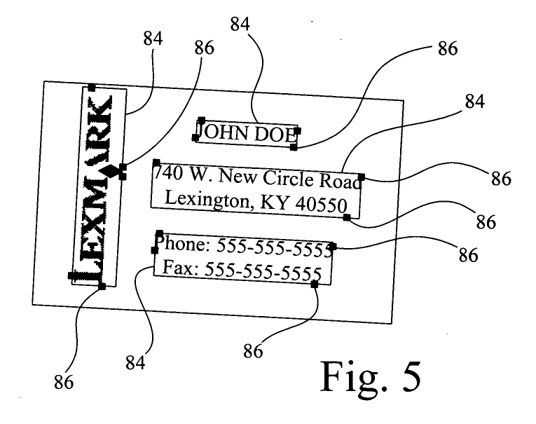

Referring now to FIG. 5, bounding boxes 84, and vertices 86 (marked with solid black squares) of each cluster of card 64 are depicted. The vertices represent the extents of the cluster in the vertical and horizontal directions. Pixels with the same color belong to the same cluster. In FIG. 5, the background pixels are set to white for illustration purposes.

To segment the cards, e.g., electronically separate the cards from one another, the ownership of the content for each card is established. Grouping determines which set of clusters belongs to a card, and accordingly, determines which clusters should be joined together based on spatial locations of each cluster. In the present embodiment, determining which clusters of the plurality of clusters should be joined together is based on an assumed minimum separation distance between the cards of multi-card image 63. Accordingly, it is assumed that the cards are separated by a minimum distance d̅ where d̅>d. The parameter d is the clustering distance used in step S106.

Given an average size of the cards of H×\tilde{W} in pixel unit at R dpi, the upper and lower bounds for the width and height for the cards satisfies the following inequality:
H₁<H<Hᵤ
W₁<\tilde{W}<Wᵤ (9)

The bounds Hₗ, Hᵤ, Wₗ and Wᵤ are selected to accommodate for the variation of card sizes for the application, e.g., tolerances for the height (H) and width (\tilde{W}), respectively, of the cards.

Referring again to FIG. 4A, at step S110-3, it is determined whether the m cluster number is less than the total number of clusters, and if m is a new cluster, e.g., a cluster that has not yet been agglomerated. If both are not true, all clusters have been agglomerated, and the algorithm ends. If both items are true, process flow proceeds to step S110-5.

Referring to now to FIG. 4B, at step S110-5, an initial search window size, W₀, is selected, and is centered at the vertex, V, under consideration. For the first pass through step S110-5, this will be the first vertex. The search window is centered at the first vertex of the cluster in the clustered bInMap.

At step S110-7, a determination is made as to whether the current search window size is less than the maximum search window size, W_{T}. If not, process flow proceeds to step S110-29, otherwise, process flow proceeds to step S110-9.

At step S110-9, it is determined whether the current vertex number, V, is less than the number of vertices for cluster m. If not, process flow proceeds to step S110-27, otherwise, process flow proceeds to step S10-111.

At step S110-11, a search for a neighboring cluster is performed as follows.

Begin searching for a pixel that belongs to a new cluster within the search window. A new cluster has a cluster label that is different from that of the current pixel and has not been searched. It must not be in the member list ML and non-member list NML of current cluster. This step is taken to avoid redundant search, which increases the processing time.

As part of determining which clusters should be joined together, the present invention includes testing to determine whether the clusters when joined fit within a predefined envelope. The testing includes temporarily joining at least two of clusters of the plurality of clusters to form provisionally combined clusters, wherein the provisionally combined clusters are permanently joined to become at least one of the superclusters if the provisionally combined clusters fit within the predefined envelope, and wherein the provisionally combined clusters are not permanently joined to become at least one of the superclusters if the provisionally combined clusters do not fit within the predefined envelope. In addition, the present invention includes determining and correcting skew angles of the clusters as part of the testing to determine whether the clusters when joined fit within the predefined envelope. The testing and skew angle detection and adjustment are set forth below in steps S110-13 to S110-25.

Accordingly, at step S110-13, the clusters are provisionally combined and analyzed as follows.

Set HasBeenSearched=TRUE for the current cluster. If a pixel that belongs to a new cluster is found, combine the two clusters temporarily to form a supercluster and compute the following features:

$${totNumPix}_{combined} = {totNumPix}_{current} + {totNumPix}_{new} \\ {i\_mean}_{combined} = \frac{\begin{matrix}{totNumPix}_{current} \cdot {i\_mean}_{current} + \\ {totNumPix}_{new} \cdot {i\_mean}_{new}\end{matrix}}{{totNumPix}_{combined}} \\ {j\_mean}_{combined} = \frac{\begin{matrix}{totNumPix}_{current} \cdot {j\_mean}_{current} + \\ {totNumPix}_{new} \cdot {j\_mean}_{new}\end{matrix}}{{totNumPix}_{combined}} \qquad ( 10 )$$

i_min_{combined}=min(i_min_{current},i_min_{new})
i_max_{combined}=max(i_max_{current},i_max_{new})
j_min_{combined}=min(j_min_{current},j_min_{new})
j_max_{combined}=max(j_max_{current},j_max_{new}) (11)
clusterHeight_{combined}=i_max_{combined}−i_min_{combined}
clusterWidth_{combined}=j_max_{combined}−j_min_{combined} (12)

$${ϕ}_{1} = {i\_mean}_{current} - {i\_mean}_{new} \\ {ϕ}_{2} = {j\_mean}_{current} - {j\_mean}_{new} \\ δ C = \frac{{totNumPix}_{current} \cdot {totNumPix}_{new}}{{totNumPix}_{combined}} [ \begin{matrix}{ϕ}_{1}^{2} & {ϕ}_{1} \cdot {ϕ}_{2} \\ {ϕ}_{2} \cdot {ϕ}_{1} & {ϕ}_{2}^{2}\end{matrix} ] \\ {C}_{combined} = {C}_{current} + {C}_{new} + δ C \qquad ( 13 )$$

Pick a vertex along each side of the bounding box for the combined cluster.
p_{—}v1_{combined}=(i_min_{combined},j):(i,j)ε{P_{current}∪P_{new}}
p_{—}v2_{combined}=(i_max_{combined},j):(i,j)ε{P_{current}∪P_{new}}
p_{—}v3_{combined}=(i,j_min_{combined}):(i,j)ε{P_{current}∪P_{new}}
p_{—}v4_{combined}=(i,j_max_{combined}):(i,j)ε{P_{current}∪P_{new}}

Referring now to FIG. 4C, at step S110-15, a determination is made as to whether height and width of the provisionally combined clusters are less than or equal to the upper limits, H_{U} and W_{U}, respectively:
If {(clusterHeight_{combined}≦Hᵤ and clusterWidth_{combined}≦Wᵤ) or
(clusterHeight_{combined}≦Wᵤ and clusterWidth_{combined}≦Hᵤ)}.

Compute the eigenvector of C_{combined}, \vec{v}=[v₁, v₂]^{T}, which corresponds to the largest eigenvalue in magnitude.

If height and width of the provisionally combined clusters are not less than or equal to the upper limits, process flow proceeds to step S110-21, otherwise, process flow proceeds to step S117.

At step S110-17, the clusters are combined, e.g., permanently joined, and the cluster m member list is incremented. The features of current cluster (cluster m) are overwritten with those computed in step S110-13, the cluster label of the new cluster is added to the member list of the current cluster, and the flag, HasBeenSearched=TRUE is set for the new cluster.

At step S110-19, the algorithm increments to the next vertex of cluster m.

Referring now to FIG. 4D, at step S110-21, skew angle detection and adjustment is performed, set forth in the present embodiment as follows.

A.) Initialize a buffer of size 2Hᵤ×2Wᵤ with 1.

B.) Center the combined cluster in this buffer.

C.) Rotate the combined cluster about the center of the buffer by tan⁻(v₂/v₁) radians.

D.) Project the rotated cluster onto the i-axis and j-axis to find the respective histograms

$${histogram}_{i} [ i ] = {\sum }_{( i , j ) ∈ \{ {P}_{current} ⋃ {P}_{new} \}} j \\ {histogram}_{j} [ j ] = {\sum }_{( i , j ) ∈ \{ {P}_{current} ⋃ {P}_{new} \}} i . \qquad ( 14 )$$

E.) Find the new clusterHeight by determining the length of the histogram beyond which all the bins of histogramᵢ have a value of 2Wᵤ. This step is repeated to obtain the clusterWidth from histogramⱼ with value 2Hᵤ.

F.) Repeat step S110-15.

G.) If the condition in step S110-15 is not met, and if
{(clusterHeight_{combined}≦2Hᵤ and clusterWidth_{combined}≦2Wᵤ) or
(clusterHeight_{combined}≦2Wᵤ and clusterWidth_{combined}≦2Hᵤ)},
perform fine angle adjustment.

In the present embodiment the following optimization scheme is employed:

1. Crop a rectangular cross-section of the combined cluster. A cross-section is used instead of the entire cluster to speed up the computation. However, the entire cluster can be used if desired, without departing from the scope of the present invention. This cross section could be either along the i-axis or j-axis. Make sure that this cross section has some content. Otherwise, grow the size of the cross-section. For the rest of this disclosure, the analysis is based on the cross-section along the i-axis (Horizontal axis). Similar approach can be adopted for the cross-section along the j-axis (Vertical axis).

2. The cross-section along the i-axis of size 2Hᵤ×2L is considered. The width of the cross section is 2L and it can be varied. Find the projection of the cross section along this axis to form a histogram using Equation (14) for the points in this cross-section. Count the number of bins with value 2L and let this sum be S₁₂^{b}.

3. Compute the number of bins with value 2L between the first and the last bin with value less than 2L. This is the total white space within the content. Let this sum be WS₁₂^{b}.

4. Split the cross-section into two parts (2Hᵤ×L each) along the i-axis. Repeat step (2) for each part and denote the sums as S₁^{b} and S₂^{b} respectively.

5. Let the angle before adjustment be θ^{b}=tan⁻¹(v₂/v₁) and let the initial incremental step for the optimization be θ₀.

6. Initialize the variable incremental step θ=θ₀.

7. Rotate the combined cluster by θ^{b}+θ and repeat steps (1)-(4) at the same spatial location as that before the rotation. Denote the sums as S₁₂⁺, S₁⁺, S₂⁺ and WS₁₂⁺ respectively.

8. Repeat step (7) with θ^{b}-θ and let the sums be S₁₂⁻, S₁⁻, S₂⁻ and WS₁₂⁻.

Find the new rotation angle:

If
{(WS₁₂⁺>WS₁₂⁻ and S₁⁺S₂⁺≧S₁⁻+S₂⁻)or(WS₁₂⁺≧WS₁₂⁻ and S₁⁺S₂⁺>S₁⁻+S₂⁻)}
WS₁₂^{a}=WS₁₂⁺
S₁₂^{a}=S₁₂⁺
S₁^{a}=S₁⁺
S₂^{a}=S₂⁺
θ^{a}=θ^{b}+θ

else if
{(WS₁₂⁺<WS₁₂⁻ and S₁⁺+S₂⁺≦S₁⁻+S₂⁻)or (WS₁₂⁺≦WS₁₂⁻ and S₁⁺+S₂⁺<S₁⁻+S₂⁻)}
WS₁₂^{a}=WS₁₂⁻
S₁₂^{a}=S₁₂⁻
S₁^{a}=S₁⁻
S₂^{a}=S₂⁻
θ^{a}=θ^{b}−θ

else if
{(S₁₂⁺<S₁₂⁻ and S₁⁺+S₂⁺≦S₁⁻+S₂⁻)or(S₁₂⁺≦S₁₂⁻ and S₁⁺+S₂⁺<S₁⁻+S₂⁻)}
WS₁₂^{a}=WS₁₂⁺
S₁₂^{a}=S₁₂⁺
S₁^{a}=S₁^{+S}₂^{a}=S₂⁺
θ^{a}=θ^{b}+θ

else if
{(S₁₂⁺<S₁₂⁻ and S₁⁺+S₂⁺≦S₁⁻+S₂⁻) or (S₁₂⁺≦S₁₂⁻ and S₁⁺+S₂⁺<S₁⁻+S₂⁻)}
WS₁₂^{a}=WS₁₂⁻
S₁₂^{a}=S₁₂⁻
S₁^{a}=S₁⁻
S₂^{a}=S₂⁻
θ^{a}=θ^{b}−θ

Else
WS₁₂^{a}=WS₁₂^{b}
S₁₂^{a}=S₁₂^{b}
S₁^{a}=S₁^{b}
S₂^{a}=S₂^{b}
θ^{a}=θ^{b}
θ=θ/2

10. Determine if an adjustment is needed:

If
{(WS₁₂^{a}>WS₁₂^{b} and S₁^{a}+S₂^{a}≧S₁^{b}+S₂^{b}) or (WS₁₂^{a}>WS₁₂^{b} and S₁^{a}+S₂^{a}>S₁^{b}+S₂^{b})}
WS₁₂^{b}=WS₁₂^{a}
S₁₂^{b}=S₁₂^{a}
S₁^{b}=S₁^{a}
S₂^{b}=S₂^{a}
θ^{b}=θ^{a}

else if
{(S₁₂^{a}>S₁₂^{b} and S₁^{a}+S₂^{a}≧S₁^{b}+S₂^{b})or(S₁₂^{a}≧S₁₂^{b} and S₁^{a}+S₂^{a}>S₁^{b}+S₂^{b})}
WS₁₂^{b}=WS₁₂^{a}
S₁₂^{b}=S₁₂^{a}
S₁^{b}=S₁^{a}
S₂^{b}=S₂^{a}
θ^{b}=θ^{a}

else if (S₁₂^{a}==S₁₂^{b})
{
θₜₑₘₚ=θ
θ=θ₀

Repeat steps (7)-(9).

If
{(WS₁₂^{a}>WS₁₂^{b} and S₁^{a}+S₂^{a}≧S₁^{b}+S₂^{b})or(WS₁₂^{a}≧WS₁₂^{b} and S₁^{a}+S₂^{a}>S₁^{b}+S₂^{b})}
WS₁₂^{b}=WS₁₂^{a}
S₁₂^{b}=S₁₂^{a}
S₁^{b}=S₁^{a}
S₂^{b}=S₂^{a}
θ^{b}=θ^{a}

else if
{(S₁₂^{a}>S₁₂^{b} and S₁^{a}+S₂^{a}≧S₁^{b}+S₂^{b})or(S₁₂^{a}≧S₁₂^{b} and S₁^{a}+S₂^{a}>S₁^{b}+S₂^{b})}
WS₁₂^{b}=WS₁₂^{a}
S₁₂^{b}=S₁₂^{a}
S₁^{b}=S₁^{a}
S₂^{b}=S₂^{a}
θ^{b}=θ^{a}

else
θ=θₜₑₘₚ
}

11. Repeat steps (7)-(10) as long as θ>θ_{T}, where θ_{T} is a chosen threshold that serves as the termination criterion for the optimization.

12. Repeat steps (A)-(F) with rotation angle θ^{b}.

At step S110-23, a determination is made as to whether height and width of the provisionally combined clusters are less than or equal to the upper limits, H_{U} and W_{U}, respectively, for example, in the manner set forth above in step S1110-15. If the condition set forth in step S110-15 is met, process flow proceeds to step S110-17. Otherwise, process flow proceeds to step S110-25.

At step S110-25, the new cluster is discarded and the cluster label of the new cluster is added to the nonmember list of the current cluster. Process flow then proceeds to step S110-19, and the current vertex number is incremented.

Referring now to FIG. 4E, at step S110-27, the search window size is increased. For example, the search-window size is increased by a factor of c, which can be varied to obtain finer or coarser search:
W=c·W, where c>1

Steps S110-7 to S110-27 are repeated as long as W<W_{T}, where W_{T} is a selected threshold to terminate the search. W_{T} could be a function of the lower bounds of a typical card Hₗ and Wₗ, as in the present embodiment, or it could be selected independently. This threshold is chosen so that no content beyond the window is combined with the current cluster.

Referring now to FIG. 4F, at step S110-29, a determination is made as to whether the supercluster size is within a predefined envelope, e.g., pertaining to an assumed size of the cards, for example, as follows.
If {(clusterHeight_{combined}≦Hₗ and clusterWidth_{combined}≦Wₗ) or
(clusterHeight_{combined}≦Wₗ and clusterWidth_{combined}≦Hₗ)}.

Find the center of the cluster, the lower left corner and the upper right corner relative to the center. Multiply these coordinates by the downsampling factors (from step S102) to obtain the corresponding coordinates in the original image imgIn.

If the supercluster size is acceptable, the provisionally joined clusters are permanently joined to be a supercluster, and process flow proceeds to step S110-31, otherwise, process flow proceeds to step S110-37.

At step S110-31, a card image is generated for the current supercluster (supercluster m).

At step S110-33, the card image for supercluster m is stored in memory, e.g., memory 36 of imaging apparatus 12 or memory 46 of host 14.

At step S110-35, the cluster number is incremented to increment to the next cluster, and process flow proceeds back to step S110-3, e.g., for a new cluster m.

Referring now to FIG. 4G, at step S110-37, skew angle detection and adjustment is performed, for example, in a similar manner as that set forth above with respect to step S110-21. The region described by the coordinates referenced in step S110-29 is rotated in the original image by θ^{b} and the rotated content is centered in an image buffer of a desired size, segmenting and aligning the card image.

At step S110-39, a determination is made as to whether the supercluster size is within the predefined envelope, for example, in a similar manner as set forth above with respect to step S110-29. If the supercluster size is acceptable, the provisionally joined clusters are permanently joined to be a supercluster, and process flow proceeds to step S110-31, the ImageGeneratedFlag=TRUE is set for all the members in the ML list of the current cluster, and a card image is generated. If not, process flow proceeds to step S1110-41.

At step S110-41, since the supercluster size was not within acceptable limits, the cluster is ignored, the IgnoreClusterFlag=TRUE is set for all the members of the NML list of the current cluster, and the provisionally joined clusters do not become a supercluster. Process flow then proceeds back to step S110-35, and the algorithm then operates on another cluster. The process is repeated for all clusters so that a supercluster is formed for each card in multi-card image 63, segmenting and aligning multi-card image 63 to form multi-card image 82.

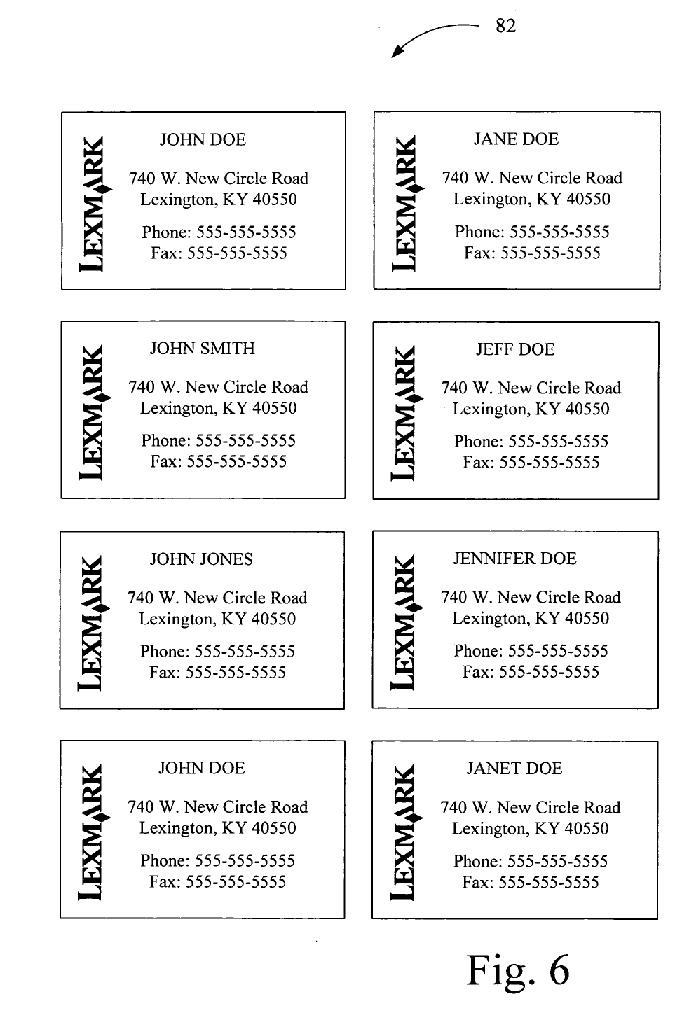

Referring now to FIG. 6, a segmented and aligned multi-card image 82 generated according to the present embodiment is depicted. The cards segmented by the algorithm were saved one at a time automatically, and the skew angle of each card was detected and corrected by the algorithm, based on steps S100-S110 and S110-1 to S110-41 as set forth above.

The following is a list of variables and parameters employed in the above description of an embodiment of the present invention.
a. imgIn—input image (original scanned image—multi-card image 63).
b. imgInD—downsampled version of imgIn.
c. R resolution of the downsampled input image imgInD.
d. s—downsampling factor.
e. imgInD(k, i, j)—k^{th} channel of the pixel of imgInD at spatial location (i,j).
f. bInMap—2D binary map used in pixel clustering (first level clustering).
   i. This is obtained by throwing away color information in imgIn. There are only two types of pixels in bInMap, the background pixels and the foreground pixels.
   ii. The foreground pixels are referred to as the content pixels.
   iii. Note: This map is modified after the clustering process.
      1. The modified map is referred to as the cluster bInMap in the disclosure.
      2. The background color stays the same in the clustering process.
      3. In the clustered bInMap, each cluster is assigned a unique number that is different from that of the background pixels.
      4. The content pixels that belong to the same cluster are assigned the same number as that of the cluster. Thus, given any pixel in the clustered map, if its value is known, it is also known which cluster to which it belongs.
      5. Statistical features of each cluster are computed and stored.
      6. Agglomeration (second level clustering—combined clusters instead of combined pixels) is performed to combine clusters using the statistical features.
g. color_{BG}(k)—k^{th} channel of the background color.
h. g(α,β,γ)—threshold function.
i. d—distance in pixel unit. Pixels that are within this distance from one another are grouped together to form a cluster.
j. p=(i, j)—a point at spatial location (i, j). This is the spatial location of a content pixel.
k. Pₘ—the set of all points in the m^{th} cluster.
l. totNumPixₘ—total number of content pixels in the m^{th} cluster.
m. (i_meanₘ, j_meanₘ)—this point corresponds to the center of mass of the m^{th} cluster.
n. (i_minₘ,j_minₘ),(i_maxₘ,j_maxₘ)—these two points are the upper left hand and lower right hand corner of the rectangular bounding box that contains the m^{th} cluster. This is not an accurate dimension of the cluster. The bounding box helps in two ways; to find the vertices that are needed in agglomeration; and allows a quick determination if the dimension of the cluster exceeds the tolerance of that of an acceptable card or object.
o. clusterHeightₘ,clusterWidthₘ—dimension of the m^{th} cluster.
p. Cₘ—sample covariance matrix of the m^{th} cluster. Each point p of Pₘ has spatial coordinates. When the set of points in Pₘ are plotted in a 2D Cartesian coordinate system, these points form a 2D scatter plot, wherein the points are correlated spatially. This sample covariance matrix indicates the degree of spatial correlation of the points, and is used to determine the initial skew angle of the cluster.
q. p_v1ₘ,p_v2ₘ,p_v3ₘ,p_v4ₘ—four points of the m^{th} cluster that intersect the bounding box of the cluster are designated as the vertices. These vertices are used in agglomeration.
r. Member list, MLₘ—this list keeps track of the clusters that are agglomerated to the m^{th} cluster to form a supercluster that pertains to a card or object to be segmented, and is employed to avoid redundant searching.
s. Nonmember list, NMLₘ—this list keeps track of the clusters that have been searched but cannot be connected with the m^{th} cluster. If these clusters are combined with the m^{th} cluster, the dimension of the resulting supercluster will exceed that of an acceptable card or object. The nonmember list was introduced to avoid redundant search to speed up the segmentation process.
t. ImageGeneratedFlagₘ—this flag was introduced to indicate that a final supercluster agglomerated to the m^{th} cluster has been found and an image for the supercluster has been generated, and is used to avoid a redundant search and ensure that only one image is generated for each card or object.
u. HasBeenSearchedₘ—this flag indicates that the m^{th} cluster has been searched and is part of a supercluster, and is used to avoid a redundant search.
v. IgnoreClusterFlagₘ—if the number of points in the m^{th} cluster is smaller than a certain value, this cluster is ignored because these pixels most likely correspond to noise pixels in the original image.

While this invention has been described with respect to exemplary embodiments, it will be recognized that the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of segmenting and aligning a plurality of cards in a multi-card image, each card of said plurality of cards having at least one object, said multi-card image having a plurality of said objects, the method comprising:
determining which pixels of said multi-card image are content pixels;
grouping together a plurality of said content pixels corresponding to each object of said plurality of said objects to form a cluster corresponding to said each object, said grouping performed for said plurality of said objects to create a plurality of clusters corresponding to said plurality of said objects;
determining which clusters of said plurality of clusters should be joined together to form a plurality of superclusters; and
forming said plurality of superclusters, each supercluster of said plurality of superclusters corresponding to one card of said plurality of cards.

2. The method of claim 1, further comprising downsampling said multi-card image.

3. The method of claim 1, wherein said determining which pixels of said multi-card image are said content pixels includes performing image binarization.

4. The method of claim 1, wherein said determining which said clusters of said plurality of clusters should be joined together includes determining geometric features for each cluster of said plurality of clusters.

5. The method of claim 4, wherein said determining which said clusters should be joined together is based on spatial locations of said each cluster.

6. The method of claim 4, wherein said determining which said clusters of said plurality of clusters should be joined together is based on an assumed minimum separation distance between said cards.

7. The method of claim 4, where said determining which said clusters should be joined together includes testing to determine whether said clusters when joined fit within a predefined envelope.

8. The method of claim 7, further comprising temporarily joining at least two of said clusters of said plurality of clusters to form provisionally combined clusters, wherein said provisionally combined clusters are permanently joined to become at least one of said superclusters if said provisionally combined clusters fit within said predefined envelope, and wherein said provisionally combined clusters are not permanently joined to become said at least one of said superclusters if said provisionally combined clusters do not fit within said predefined envelope.

9. The method of claim 7, further comprising determining skew angles for said clusters as part of said testing to determine whether said clusters when joined fit within said predefined envelope.

10. The method of claim 1, wherein said grouping together said plurality of said content pixels includes:
searching said multi-card image in raster order until a first content pixel is located; and
grouping with said first pixel the neighboring content pixels that are within a predetermined spatial proximity of said first content pixel to form an initial cluster.

11. The method of claim 10, further comprising:
determining which content pixels of said initial cluster are boundary pixels; and
grouping with said initial cluster the neighboring content pixels that are within said predetermined spatial proximity of each boundary pixel of said boundary pixels to form said cluster.

12. The method of claim 1, wherein said multi-card image is a scanned image.

13. The method of claim 1, further comprising determining a spatial relationship between each card of said plurality of cards.

14. The method of claim 13, further comprising aligning said plurality of cards.

15. The method of claim 1, wherein said method is performed without detecting any edges of any of said plurality of cards.

16. The method of claim 1, wherein each card of said plurality of cards includes a boundary region and an interior region, and wherein said method is performed based on using pixels only in said interior region of said each card.

17. An imaging apparatus communicatively coupled to an input source and configured to receive a multi-card image, said imaging apparatus comprising:
a print engine; and
a controller communicatively coupled to said print engine, said controller being configured to execute instructions for segmenting and aligning a plurality of cards in a multi-card image, each card of said plurality of cards having at least one object, said multi-card image having a plurality of said objects, said instructions including:
determining which pixels of said multi-card image are said content pixels;
grouping together a plurality of said content pixels corresponding to each object of said plurality of said objects to form a cluster corresponding to said each object, said grouping performed for said plurality of said objects to create a plurality of clusters corresponding to said plurality of said objects;
determining which clusters of said plurality of clusters should be joined together to form a plurality of superclusters; and
forming said plurality of superclusters, each supercluster of said plurality of superclusters corresponding to one card of said plurality of cards.

18. The imaging apparatus of claim 17, further comprising said controller being configured to execute instructions for downsampling said multi-card image.

19. The imaging apparatus of claim 17, wherein said determining which pixels of said multi-card image are said content pixels includes performing image binarization.

20. The imaging apparatus of claim 17, wherein said determining which said clusters of said plurality of clusters should be joined together includes determining geometric features for each cluster of said plurality of clusters.

21. The imaging apparatus of claim 20, wherein said determining which said clusters should be joined together is based on spatial locations of said each cluster.

22. The imaging apparatus of claim 20, wherein said determining which said clusters of said plurality of clusters should be joined together is based on an assumed minimum separation distance between said cards.

23. The imaging apparatus of claim 20, where said determining which said clusters should be joined together includes testing to determine whether said clusters when joined fit within a predefined envelope.

24. The imaging apparatus of claim 23, further comprising said controller being configured to execute instructions for temporarily joining at least two of said clusters of said plurality of clusters to form provisionally combined clusters, wherein said provisionally combined clusters are permanently joined to become at least one of said superclusters if said provisionally combined clusters fit within said predefined envelope, and wherein said provisionally combined clusters are not permanently joined to become said at least one of said superclusters if said provisionally combined clusters do not fit within said predefined envelope.

25. The imaging apparatus of claim 23, further comprising said controller being configured to execute instructions for determining skew angles for said clusters as part of said testing to determine whether said clusters when joined fit within said predefined envelope.

26. The imaging apparatus of claim 17, wherein said grouping together said plurality of said content pixels includes:
searching said multi-card image in raster order until a first content pixel is located; and
grouping with said first pixel the neighboring content pixels that are within a predetermined spatial proximity of said first content pixel to form an initial cluster.

27. The imaging apparatus of claim 26, further comprising said controller being configured to execute instructions for:
determining which content pixels of said initial cluster are boundary pixels; and
grouping with said initial cluster the neighboring content pixels that are within said predetermined spatial proximity of each boundary pixel of said boundary pixels to form said cluster.

28. The imaging apparatus of claim 17, wherein said multi-card image is a scanned image.

29. The imaging apparatus of claim 17, further comprising said controller being configured to execute instructions for determining a spatial relationship between each card of said plurality of cards.

30. The imaging apparatus of claim 29, further comprising said controller being configured to execute instructions for aligning said plurality of cards.

31. The imaging apparatus of claim 17, wherein said instructions are executed without detecting any edges of any of said plurality of cards.

32. The imaging apparatus of claim 17, wherein each card of said plurality of cards includes a boundary region and an interior region, and wherein said instructions are executed based on using pixels only in said interior region of said each card.

33. The imaging apparatus of claim 17, further comprising a scanner, wherein said input source is said scanner.

34. The imaging apparatus of claim 17, wherein said input source is a scanner.
